(19) United States
(12) Patent Application Publication
(10) Pub. No.: US 2026/0125188 A1
(43) Pub. Date: May 7, 2026

(54) DEVICE FOR PACKAGING VARIOUS TYPES OF FOOD PRODUCTS, AND USE THEREOF

(71) Applicant: SEBAT, Strasbourg (FR)

(72) Inventors: Claude BOUTELOUP HENRI, Sivignon (FR); David NOURAUD, Wroclaw (PL)

(73) Assignee: SEBAT, Strasbourg (FR)

(21) Appl. No.: 19/105,846

(22) PCT Filed: Aug. 30, 2023
(86) PCT No.: PCT/IB2023/058561

§ 371 Date: Feb. 24, 2025

(30) Foreign Application Priority Data
Sep. 1, 2022 (FR) FR2208767

(51) Int. Cl. B65D 43/02; A47J 47/14

(52) U.S. Cl. CPC B65D 43/0216; A47J 47/145; B65D 43/022; B65D 2585/366

(57) ABSTRACT

The invention relates to a device which essentially comprises a bottom piece, a cover, a base, and a cloche. The base and the cloche, which are able to form a closed receiving chamber inserted between the bottom piece and the cover, adopt two different configurations: a first configuration in which the base is resting on the bottom piece such that the chamber can receive a solid food product, for example a pizza; and a second configuration in which the cloche is resting on the bottom piece such that the chamber can receive a different, non-solid, food product.

### CROSS-REFERENCE TO RELATED APPLICATIONS

The present application is a National Stage Application of PCT International Application No. PCT/IB 2023/058561 (filed on Aug. 30, 2023), under 35 U.S.C. § 371, which claims priority to French Patent Application No. FR 2208767 (filed on Sep. 1, 2022), which are each hereby incorporated by reference in their complete respective entireties.

### TECHNICAL FIELD

The invention relates to the technical field of food products, in particular so-called take-away products. It relates more particularly to a packaging device enabling the transport of food products of different types, from their place of manufacture to their place of consumption. For the purposes of the invention, a first type of food product is said to be solid, for example in that it comprises a food paste, such as in particular a pizza. A second type of food product is said to be non-solid, for example because it has a liquid or pasty consistency.

### BACKGROUND

In general, food products constitute an industrial market of considerable size. Traditionally, these products are consumed on site in restaurants. There has also emerged a need for so-called “fast” consumption of these products. In such fast consumption, the buyer most often takes the food product with him to eat it in public places, on means of transport, or even on the street.

Another possibility, more particularly targeted by the present invention, consists of transporting food products from their place of manufacture to the place where they are eaten, most often to the consumer's home. In this case, the customer can go directly to the place of manufacture, in order to collect the food product himself and then take it home. Alternatively, the consumer can choose to have the food product delivered by a courier, directly to his home.

In either case, there are different types of containers that allow the transport of food products. So, in the case of pizzas, an individual cardboard box is used, usually square in shape. In the case of food products with a fluid consistency, these are received in cups or pots, which can also be made of cardboard or even so-called “kraft” paper.

The various solutions currently available on the market have a number of drawbacks. First of all, it is necessary to provide several types of containers, depending on the nature of the food products to be transported. This tends to make the restaurateur's job more complicated, while creating an increase in overall costs.

Furthermore, the various containers used are most often single-use, meaning they are not recyclable. In fact, these containers are generally soiled by the ingredients of different food products. Under these conditions, due to the very high number of containers in circulation, the lack of recycling generates considerable quantities of waste, which leads to a significant ecological problem.

Furthermore, it has been observed that conventional containers do not have very satisfactory insulating power. Under these conditions, food products may not be at a sufficient temperature when they arrive at the consumer's home. It is certainly possible to reheat these products afterwards: however, this implies a delay in consumption and, if this reheating is carried out in a microwave oven, a deterioration in taste quality.

We will cite U.S. Pat. No. 2,828,903 which describes a disposable container, having thermal insulation properties allowing the preservation of hot or cold foods at the right temperature. This container includes an outer container, made of cardboard whose inner walls are coated with thermal insulation material. An inner container, made of the same material, is received in the outer container using a centering device.

The solution described in this document does not provide any avenues for improvement with regard to the problem posed. In fact, the container above is disposable, so it is absolutely not suitable for successive uses. Furthermore, the centering device forms a separate part, which can therefore be lost in service. Finally, this document does not deal with the packaging of food products more particularly targeted by the invention, such as pizzas.

Finally, we will mention the Belgian Patent Publication No. BE 1014682, which describes a rudimentary solution which is generally similar to that proposed in the American patent above.

### SUMMARY

In view of the foregoing, an objective of the present invention is to remedy, at least partially, the drawbacks of the prior art discussed above.

Another objective of the invention is to provide a versatile device, in that it lends itself easily to the packaging and transport of food products of different types, in particular solid and non-solid as defined above.

Another objective of the invention is to provide a device that can be assembled quickly and intuitively, without extending the time taken to fill the food product at the manufacturing site.

Another objective of the invention is to propose a device suitable for recycling, that is to say which is suitable for the packaging and transport of a large number of successive food products.

Another objective of the invention is to propose such a packaging device which ensures effective thermal insulation, so as to preserve the food product at an optimum temperature for consumption.

According to the invention, at least one of the above objectives is achieved by means of a packaging device (I; II; III) suitable for packaging food products of different types, in particular of solid and non-solid types respectively, this device comprising a bottom piece (1; 101; 201) and a cover (2; 102; 202) movable relative to the bottom piece between a closed position, in which they delimit an interior volume (V), and a position for access to this interior volume, this device further comprising a sole (4; 104; 204) and a bell (6; 106; 206), the height (H6) of the bell being significantly greater than the height of the sole, this sole and this bell being capable of forming a substantially closed receiving enclosure (3,3′; 103,103′; 203,203′), which is housed in said interior volume, said receiving enclosure being capable of receiving, successively, food products of different types, said sole and said bell being capable of adopting two different configurations, namely:
a first configuration in which the sole rests on the bottom piece, so that the enclosure (3; 103; 203) can receive a solid food product, for example a pizza (P), and
a second configuration in which the bell rests on the bottom piece, so that the enclosure (3′; 103′; 203′) can receive another non-solid food product.

According to other features of the invention of the packaging device according to the invention:
the bottom piece and the cover are at least partly made of a moldable plastic material, in particular capable of being injected, in particular expanded polystyrene, while the sole and the bell are made of stainless steel;
in the first configuration, the bell and the cover mutually delimit a first so-called upper intermediate space (8; 108; 208), of thermal insulation, while the sole and the bottom piece mutually delimit a so-called first lower intermediate space (9; 109; 209), of thermal insulation;
in the second configuration, the sole and the cover mutually delimit a so-called second upper intermediate space (8′; 108′), of thermal insulation, while the bell and the bottom piece mutually delimit a so-called second lower intermediate space (9′; 109′), of thermal insulation;
in the second configuration, the cover (206) rests directly on the bottom piece (201), without defining an intermediate space;
the sole and the bell delimit zones (E, E′; E1, E′1) of mutual nesting, both in the first configuration and in the second configuration;
the sole and the bell delimit a mutual nesting zone (E′2), only in the second configuration, the sole having a rim (242) projecting opposite the bell in the first configuration;
the rim rests on the bottom piece in the first configuration, so as to define the lower intermediate space (E209);
in the first configuration, the upper surface (S240) of the sole is located at a height substantially equal to that of the upper surface (S212) of the bottom piece;
the bottom piece delimits a first blocking zone (B; B1; B2) with the sole, in the first configuration, as well as a second blocking zone (B′; B′1; B′2) with the bell, in the second configuration;
the bottom piece includes support means, which are suitable for supporting the sole in the first configuration as well as the bell in the second configuration, these support means comprising in particular a continuous peripheral collar (14), or several point supports (114) ;
the bottom piece has a base extended upwards by a seat (212) whose internal face (213) is smooth, so as to define the blocking zone with the sole and with the bell;
the cover is movable relative to the bottom piece, between the closed position and the access position, according to a vertical sliding movement with reference to a device resting on its bottom piece, the device advantageously comprising rapid locking means between the cover and the bottom piece;
the cover (2) has an internal diameter which is close to the external diameter of the bottom piece (1), the internal wall of this cover being able to cover the external wall of this bottom piece;
the external diameters respectively of the bottom piece (101) and of the cover (102) are substantially identical, the mutual fixing between this base and this cover being ensured by the cooperation between a barrel (122) of the cover and a seat (112) of the bottom piece (101), in particular by the cooperation by interlocking between a skirt (116) formed on said barrel and a thin wall (124) provided on said seat;
the mutual fixing between the bottom piece and the cover is ensured by electrical snap-fastening, in particular between a rib of the cover penetrating removably into a groove in the bottom piece; and
the plate is pierced with holes to allow condensation from the solid food product such as pizza to evacuate, in the first configuration.

These additional features may be implemented with the above main object, individually or in any technically compatible combinations.

The invention also relates to the use of a device such as above, for the successive packaging and transport of food products of different types, for example a solid food product, for example comprising a food dough, such as a pizza (P), and then for example a non-solid food product(S).

According to other features of the above use:
the bottom piece, the cover, the sole and the bell are assembled together, at the same time as the food product to be transported is filled, so that this assembly takes place in hidden time;
immediately before filling the food product, the sole and the bell are heated to a temperature close to that of the food product;
the sole (4) is placed on the bottom piece (1), the solid food product (P) is placed on the sole, the bell (6) is placed on the sole so as to form the receiving enclosure (3), then this enclosure is covered using the cover (2); and
the bell (6) is placed on the bottom piece, the non-solid food product (S) is poured into the bell, the sole (4) is placed on the bell so as to form the receiving enclosure (3′), then this enclosure is covered using the cover (2).

These additional features may be implemented with the second main object above, individually or in any technically compatible combinations.

### DRAWINGS

The invention will be described below, with reference to the attached drawings, given solely as non-limiting examples, in which:

FIG. 1 is a perspective view, generally illustrating a food product packaging device, in accordance with a first embodiment of the invention.

FIG. 2 is a perspective view, with parts broken away, illustrating in an exploded manner the various constituent elements of this device.

FIG. 3 is a diametrical sectional view, illustrating on a larger scale the placing of a pizza on a sole, belonging to a receiving enclosure of this packaging device.

FIG. 4 is a diametrical sectional view, similar to FIG. 3, illustrating the installation of a bell belonging to the receiving enclosure, then of the cover of this conditioning device.

FIG. 5 is a diametrical sectional view, similar to FIG. 3, illustrating the filling of a portion of soup in the bell of FIG. 4, in another configuration of the receiving enclosure.

FIG. 6 is a diametrical sectional view, similar to FIG. 5, illustrating the positioning of the sole above the bell, then of the cover as in FIG. 4.

FIG. 7 is a perspective view, similar to FIG. 1, illustrating a packaging device according to a second embodiment of the invention.

FIG. 8 is a perspective view, illustrating the sole and the bell forming the receiving enclosure of the device of FIG. 7.

FIG. 9 is a perspective view, illustrating the bottom piece and cover belonging to the device of FIG. 7.

FIG. 10 is a diametrical sectional view illustrating the device of FIGS. 7 to 9.

FIG. 11 is an enlarged diametrical sectional view, similar to FIG. 3, illustrating the placement of a pizza on the sole of the device of FIGS. 7 to 10; and

FIG. 12 is a larger-scale diametrical sectional view, similar to FIG. 5, illustrating the filling of a portion of soup in the bell of the device of FIGS. 7 to 11.

FIG. 13 is a diametrical sectional view, similar to FIG. 11, illustrating the placement of a pizza on the sole of a packaging device according to a third embodiment of the invention.

FIG. 14 is a diametrical sectional view similar to FIG. 13, illustrating the sliding of the pizza along the sole and then out of the device according to this third embodiment.

FIG. 15 is a diametrical sectional view, similar to FIG. 12, illustrating the filling of a portion of soup in the bell of the device according to this third embodiment.

### DESCRIPTION

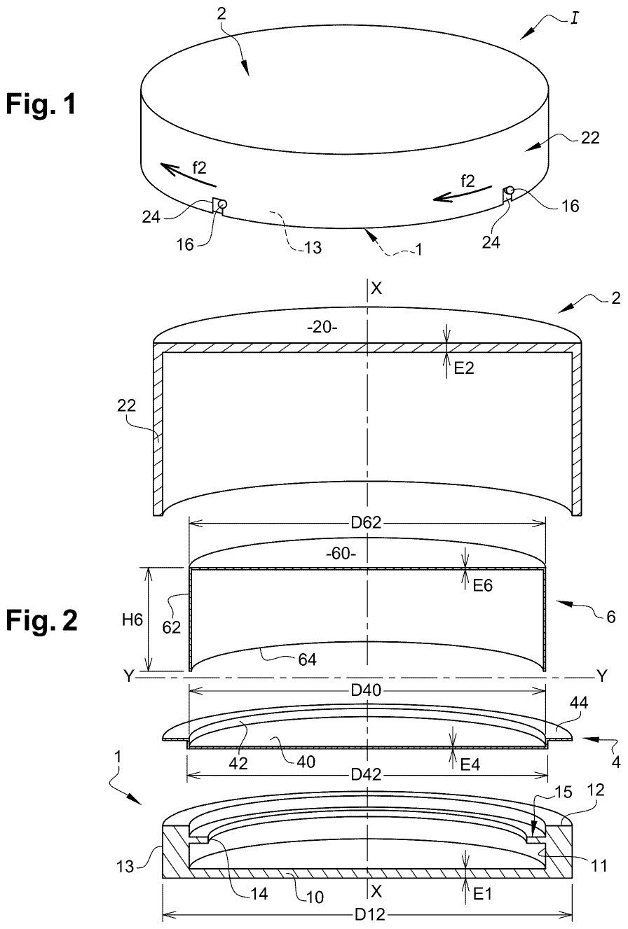

FIGS. 1 to 6 illustrate a packaging device according to a first embodiment of the invention, designated as a whole by the reference I. This device is more particularly suited to receiving different types of food products. As seen above, the invention more particularly relates to such a device suitable for packaging both solid and non-solid products. In the various figures, in particular FIGS. 2 to 6, the actual proportions of the various constituent parts of device I are not necessarily shown to scale, for the sake of clarity in the drawings. Furthermore, these proportions may vary from one figure to another, in order to better emphasize the different features of the invention.

This device I firstly comprises a bottom piece 1, as well as a cover 2 capable of cooperating with this bottom piece. In the following, the terms “upper”, “lower”, “central”, “peripheral”, “horizontal” and “vertical” are used in reference to a normal operating position of the device. Essentially, this normal position corresponds to a bottom piece resting on a horizontal surface, for example a table. It is also noted, on FIG. 2, XX and YY the longitudinal and transverse directions respectively of the device I.

In more detail, the bottom piece 1 comprises a base 10, from which a cylindrical neck 11 extends upwards. The latter is extended by a peripheral seat 12, surrounded by a side wall 13. Finally, a collar 14 extends radially inwards from the neck 11. This collar delimits, with the seat 12, a shoulder 15 whose function will be described below. In order to guarantee optimum stability, in particular by avoiding any slipping, the lower face of the base is advantageously equipped with stabilizing pins not shown.

The cover 2 firstly comprises a circular roof 20, the diameter of which is slightly greater than that of the bottom piece. This roof is extended, downwards, by a cylindrical barrel 22. The typical thickness, respectively E1 and E2 in FIG. 2, of the bottom piece and the cover is between 2 and 6 millimeters (mm), in particular close to 4 mm. This thickness may vary in particular, depending on the overall dimensions of the packaging device. The bottom piece 1 and the cover 2 define an interior volume V, visible in particular in FIGS. 4 and 6, which is intended for housing a reception enclosure as will be seen below.

Advantageously, this bottom piece and this cover are provided with additional quick locking means. In the example illustrated, with reference to FIG. 1, the side wall 13 has at least one pin 16, in particular of hemispherical shape. Preferably, a plurality of pins are provided, for example four in number, distributed regularly in a regular manner. Each pin cooperates with a notch 24, made at the lower end of the barrel 22. Given their profile, advantageously L-shaped, the different notches allow the respective pins to be blocked, which guarantees reliable locking between the bottom piece and the cover.

According to an advantageous characteristic of the invention, both the bottom piece 1 and the cover 2 are made of a moldable plastic material. It is therefore suitable for industrial molding operations, particularly injection molding, so that it can be manufactured in large series. This moldable material is advantageously a plastic material having insulating properties, such as expanded polystyrene by way of non-limiting example. Such a material can also be of the “bioplastic” type, i.e. for example made from sugar cane or similar, or even wood-based.

The sole 4, which has the shape of a disc, delimits a horizontal plate 40 intended for receiving a solid food product, as will be seen below. This plate 40 is extended by a vertical projection 42, forming a rim, itself ending in a peripheral crown 44. The bell 6 firstly comprises a roof 60, from which extends a cylindrical rim 62. Unlike the bottom piece and the cover, the sole and the bell are not made of a plastic material, but preferably of stainless steel. The typical thickness, respectively E4 and E6 in FIG. 2, of both the sole and the bell, is between 1 and 3 mm, in particular close to 2 mm. As above, this thickness may possibly vary depending on the overall dimensions of the packaging device.

The respective dimensions of the sole 4 and the bell 6 are such that they allow both mutual interlocking between these two parts, but also blocking of each of these parts relative to the bottom piece 1. Under these conditions, with reference to FIG. 2, the external diameter D62 of the rim 62 is close to the external diameter D40 of the plate 40. Furthermore, the diameter D42, taking into account the thickness of the rim 42, is similar to the internal diameter D12 of the seat 12.

The overall dimensioning of the device described above depends, first of all, on the size of the food products it must receive. In the case where this device is intended for receiving, among other things, pizzas, the size of which may vary in particular depending on the country, the external diameter of the bottom piece is chosen as an indication between 20 and 70 centimeters. Depending on the value of this diameter, we will choose a bell height H6, visible in FIG. 2, which is well adapted to the usual volume of non-solid food product served during each sale.

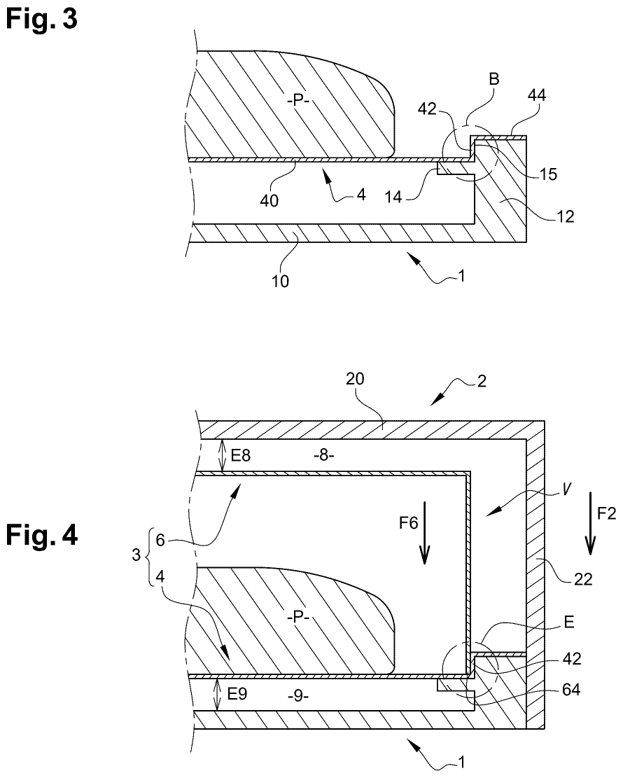

The use of the conditioning device I, which was described above, will now be explained in particular with reference to FIGS. 3 to 6.

It is first assumed that it is desired to package a solid food product, in particular a product based on food dough such as a pizza P. To this end, as illustrated in FIG. 3, the sole 4 is attached to the bottom piece 1 by making the rim 42 cooperate with the shoulder 15. The sole is then blocked relative to the bottom piece, at the level of zone B, while the peripheral crown 44 rests on the seat 12.

As shown in this FIG. 3, the operator can then place the pizza P directly on the plate 40, advantageously immediately after it comes out of the oven. As illustrated in FIG. 4, this operator then covers both the plate 40 and the pizza, using the bell 6 according to arrow F6. At the end of this movement, the perimeter 64 of the rim 62 is fitted against the inner face of the rim 42 opposite, at the level of zone E.

According to an advantageous characteristic of the invention, both the sole 4 and the bell 6 are heated to a temperature close to that of the pizza, before placing the latter on the plate. In these conditions, there is no significant heat exchange between the pizza on the one hand and the sole and the bell on the other. Therefore, before eating, the pizza tends to cool very little. This is advantageous in economic terms, since the consumer has little or no need to reheat the pizza. Furthermore, avoiding such reheating allows the pizza′s taste qualities to be better preserved.

In this first configuration of FIG. 4, the sole and the bell form a first receiving enclosure 3, more particularly intended for a solid food product, given that reception is ensured by the sole. It should be noted that this generally closed reception enclosure is directly bordered by the sole 4 and the cover 6 in stainless steel, which is particularly advantageous in terms of thermal insulation. The term “directly” means that no other mechanical parts, especially plastic, are interposed between the pizza and the above stainless-steel elements.

Still referring to FIG. 4, the operator finally brings the cover 2 around the bottom piece, which supports both the sole, the pizza and the bell. This step, which is carried out using an axial movement from top to bottom, is shown by the arrows F2. During this axial movement, the operator first makes each pin 16 enter the entrance of a respective notch 24. Then he rotates the cover, according to arrow f2 in FIG. 1, so as to place this pin in this notch. The receiving enclosure is then housed in the interior volume V, defined by the bottom piece and the cover. The packaging device I according to the invention is therefore ready to be transported, either by the end consumer himself or by a specialized courier.

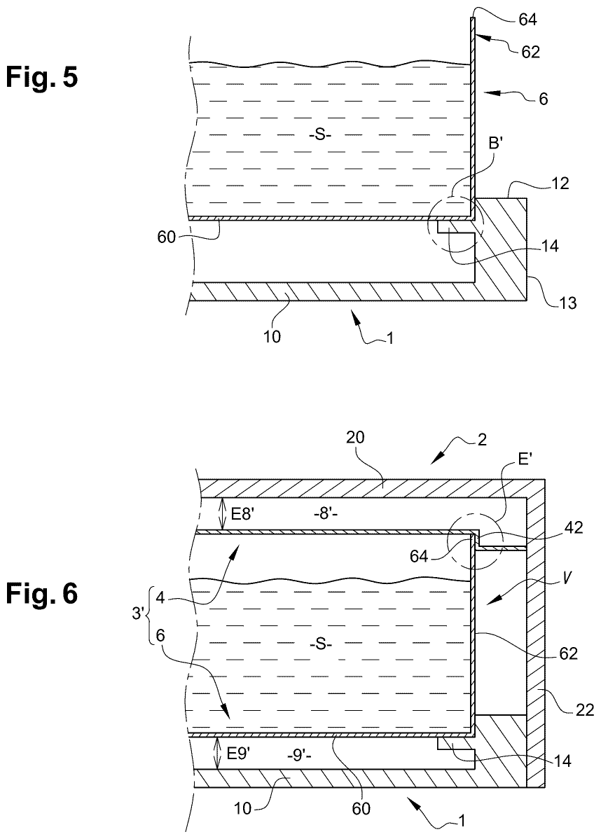

We assume in a second step that we wish to package a non-solid food product, for example a portion of a soup marked S. To this end, with reference to FIG. 5, we attach to the bottom piece 1, not the sole 4 as above, but the bell 6. Under these conditions, the roof 60 of this bell rests against the upper face of the collar 14, being blocked laterally by the walls of the shoulder 15 at the level of zone B′.

As shown in FIG. 5, the operator can then pour the soup S directly into the bell 6, up to a certain level of its rim 62. Similarly to what was described above, with reference to the placement of the pizza on the sole, it is advantageous to preheat the sole and the bell to a temperature close to that of the soup S. As illustrated in FIG. 6, this operator then brings the sole 4 to the level of the zone E′, by fitting the rim 42 around the perimeter 64.

In this second configuration of FIG. 6, the sole and the bell form a second receiving enclosure 3′, which is turned over relative to the first enclosure 3 above. Finally, in a manner similar to what was described with reference to FIG. 4, the operator covers the bottom piece 1 using the cover 2, then locks these two parts together. The packaging device according to the invention, now containing a non-solid food product, is then ready to be transported.

As is more particularly shown in FIGS. 4 and 6, the conditioning device delimits different intermediate spaces, in one or other of the configurations adopted by the receiving enclosure 3 respectively 3′. Thus, in the first configuration of FIG. 4, the cover 2 and the bell 6 delimit an upper intermediate space 8, while the bottom piece 1 and the sole 4 delimit a lower intermediate space 9. Furthermore, in the second configuration of FIG. 6, the cover 2 and the sole 4 delimit another upper intermediate space 8′, while the bell 6 delimits with the bottom piece 1 another lower intermediate space 9′.

The upper intermediate spaces 8 and 8′ have similar thicknesses, noted E8 and E8′ in FIGS. 4 and 6. Typically, the value of these thicknesses E8 and E8′ is between 6 and 8 millimeters. Similarly, the lower intermediate spaces 9 and 9′ have similar thicknesses, noted E9 and E9′ in this same FIGS. 4 and 6. Typically, the value of these thicknesses E9 and E9′ is also between 6 and 8 mm. It should be noted that these different thicknesses are generally invariant, whatever the overall dimensions of the packaging device. Furthermore, each upper space 8 or 8′ typically has a thickness that is similar, in particular identical, to the thickness of each lower space 9 or 9′.

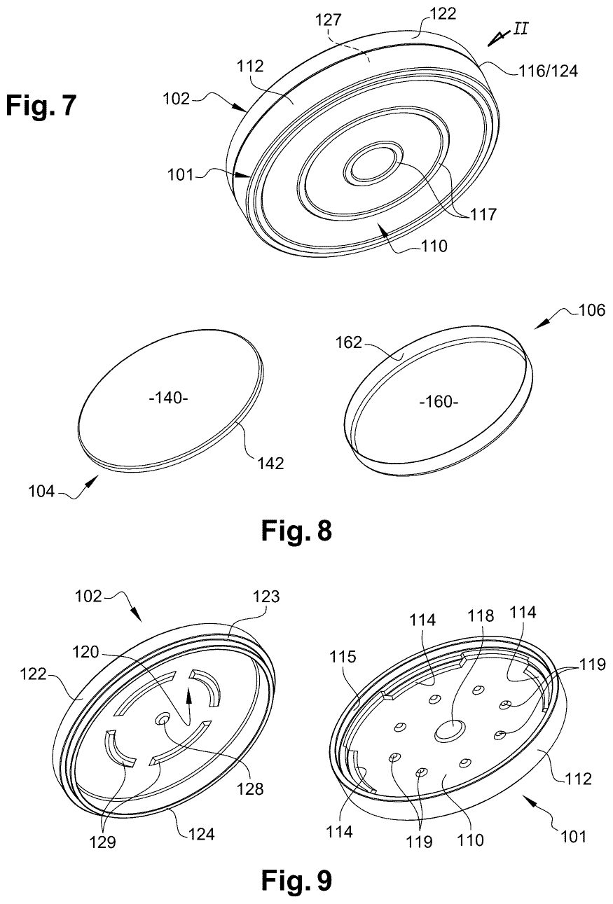

FIGS. 7 to 12 illustrate a second embodiment of the food product packaging device, in accordance with the invention. In these FIGS. 7 to 12, the mechanical elements, similar to those of FIGS. 1 to 6 described above, are assigned the same reference numbers increased by the number 100.

The packaging device according to this second embodiment, which is designated as a whole by the reference II, differs first of all from that I by the structure of the sole 104. In fact, the latter is devoid of a crown, such as that 44, so that this sole 104 is formed by a plate 140 extended only by a projecting edge 142.

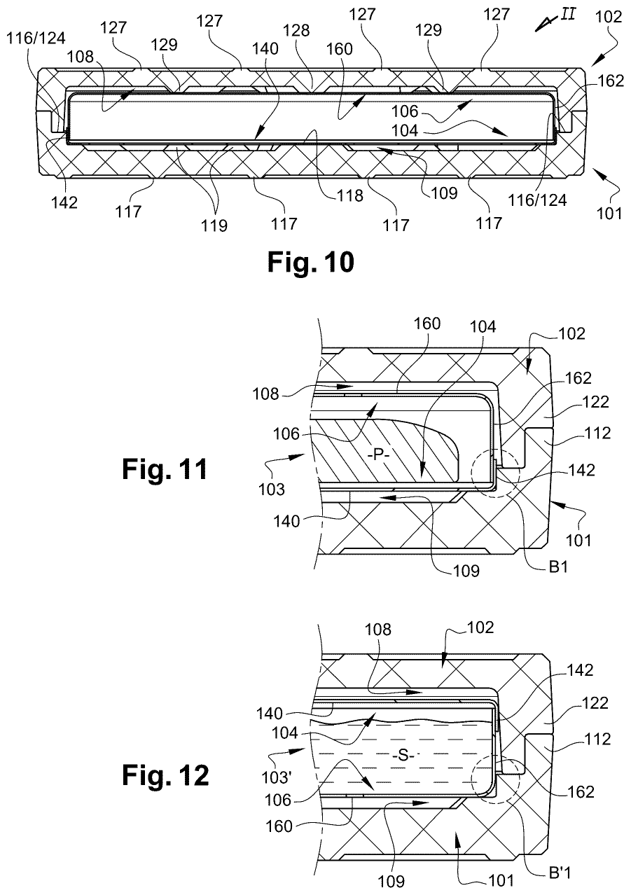

The removal of this crown makes it possible to reduce the external diameter of the cover 102, which is substantially identical to that of the bottom piece 101. As shown in particular in FIG. 10, the mutual fixing between this bottom piece and this cover is ensured by a skirt 124 formed on the barrel 122 of the cover, cooperating by fitting with a thin wall 116 provided on the seat 112 of the bottom piece. As a variant not shown, other fixing systems can be provided, replacing or supplementing the one described above. These include the use of cleats, an external closing system, or the like.

The bottom piece 101 also differs from that 1 in that it does not have a continuous support collar 14. On the contrary, the seat 112 of the bottom piece 101 comprises a plurality of support surfaces 114, each extending over a small angular sector. Furthermore, the base 110 of the bottom piece 101 comprises a central boss 118, as well as a plurality of reliefs 119 provided in the vicinity of this boss. Similarly, the roof 120 of the cover 102 is also equipped with a central boss 128 and peripheral reliefs 129. Finally, the external faces respectively of the base 110 and the roof 120 are provided with ribs 117 and 127, ensuring a stiffening function.

The use of the conditioning device II, described with reference to FIGS. 7 to 12, is generally similar to that of device I which was explained above. Referring to FIG. 11, if it is desired to package a food dough product such as a pizza P, the sole 104 is placed on the bottom piece 101. The plate 104 of this sole rests, on the one hand, on the supports 114, and on the other hand, on the boss 118 and the reliefs 119. We note B1 the blocking zone of the sole relative to the bottom piece, in this first configuration.

Then we bring the pizza P back onto the plate 140, before covering the sole using the cover. There is a mutual nesting zone between the sole 104 and the bell 106, as in the first embodiment. Furthermore, the boss 128 and the reliefs 129 of the cover 102 bear against the roof 160 of the bell. As described with reference to the first embodiment, it is advantageous to heat both the sole and the bell to a temperature close to that of the pizza, immediately before inserting the latter into the receiving enclosure 103. The operator finally brings the cover 102 against the bottom piece 101, making the skirt 116 and the barrel 122 cooperate. In the configuration of FIG. 11, we find intermediate spaces 108 and 109, similar to those 8 and 9 of the first embodiment.

If it is desired to package a non-solid food product such as a soup S, the bell 106 is placed on the bottom piece 101 as shown in FIG. 12. The roof 160 of the bell 106 then rests on the bearing surfaces 114, as well as on the boss 118 and the reliefs 119. Just as in the first embodiment, the soup S is then poured into the interior volume of the bell, before bringing back the sole 104. We note B′1 the blocking zone between the bell and the bottom piece, while there is a nesting zone between the bell and the sole as above. The cover 102 is then attached to the bottom piece, as in FIG. 11. In this second configuration, illustrated in FIG. 12, we find intermediate spaces 108′ and 109′, similar to those 8′ and 9′ of the first embodiment.

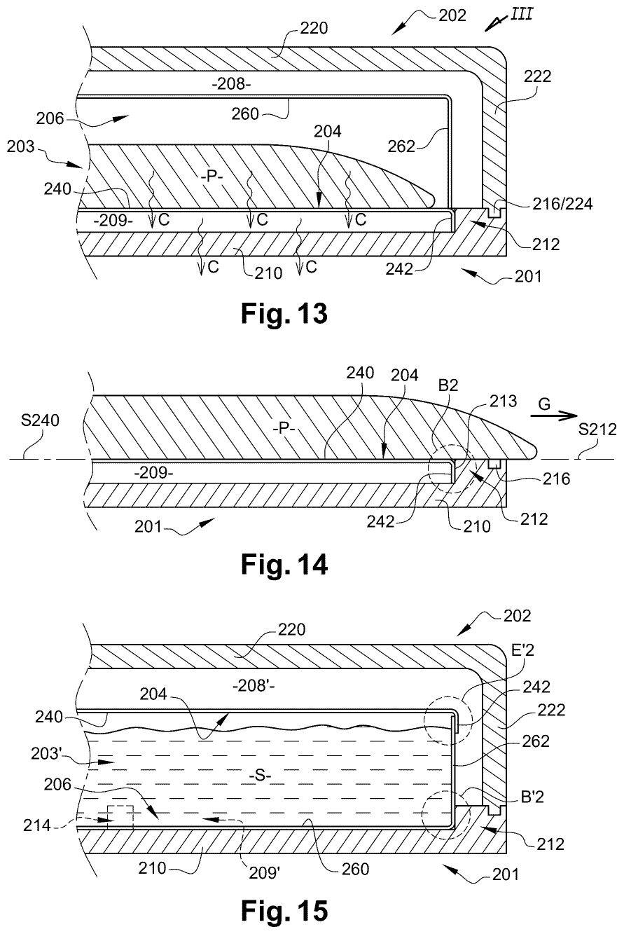

FIGS. 13 to 15 illustrate a third embodiment of the food product packaging device, in accordance with the invention. In these FIGS. 13 to 15, the mechanical elements, similar to those of the second embodiment described in FIGS. 7 to 12, are assigned the same reference numbers increased by the number 100.

The packaging device according to this third embodiment, which is designated as a whole by the reference III, first of all has a sole 204 similar to that 104 of the device II. Thus this sole 204 comprises a plate 240 extended by a rim 242, without a peripheral collar. Furthermore, the structure of the bell 260 is similar to that of the bell 160, belonging to device II.

On the other hand, the bottom piece 201 and the cover 202 of the device III differ from the mechanical elements 101 and 102 of the device II, in particular in that they have a simplified structure. Thus the bottom piece 201 comprises a base 210 extended upwards by a seat 212, in the upper part of which a peripheral groove 216 is formed. The cover 202 comprises a roof 220 extended downwards by a barrel 222, the lower part of which is provided with a peripheral rib 224. This rib is able to cooperate, by elastic snap-fastening, with the groove 216. This provides a reliable attachment between the bottom piece and the cover, which can be easily removed.

The implementation of Device III, which will be described below, differs substantially from those of devices I and II above. As shown in particular in FIGS. 13 and 14, in the first functional configuration, the sole 204 rests directly on the base 210 of the bottom piece 201. For this purpose, unlike the embodiments of FIGS. 1 to 12, the rim 242 does not protrude upwards, but on the contrary downwards. Therefore, the presence of this rim 242 contributes to forming the intermediate space 209. This feature makes it possible to simplify the structure of the bottom piece, namely that the internal face 213 of the seat 212 is advantageously smooth. We note B2 the blocking zone between this smooth face 213 and the rim 242, by analogy with the previous zones B and B1.

Furthermore, the plate 240 of the sole is advantageously pierced with small holes, not shown. As shown in particular in FIG. 13, these orifices allow the evacuation of condensation coming from the pizza, which is materialized by the arrows C. In addition, by advantageously providing a bottom piece made of a material with high porosity, such condensation can be extracted from the device through this bottom piece, according to the arrows C′. It will be noted that the feature described in this paragraph can be combined with the other embodiments.

FIG. 14 illustrates a particularly advantageous characteristic of the invention. As seen above, the rim 242 does not protrude above the plate 240. Furthermore, the surface S240 of this plate is located substantially at the same height as the upper surface S212 of the seat 212. With this in mind, it is chosen to provide a female fixing element, such as groove 216, in seat 212 and not in the cover. When tasting the pizza, after removing the cover 202 and the bell 206, this pizza can be slid along the base and the upper surface of the seat, according to the arrow G. This is particularly convenient for the consumer.

As shown in FIG. 15, the implementation of device III also differs from those of devices I and II in the second functional configuration. In fact, the roof 260 of the bell 206 rests directly on the base 210, so that there is no intermediate space similar to those 9 and 109 of the previous figures. However, as a variant materialized in dotted lines, it is possible to provide for forming a boss 214 on this base. This makes it possible to raise the cover 206 and, in this way, to create an intermediate space 209′ also shown in dotted lines.

Furthermore, in this second functional configuration, the sole 204 and the cover 206 are mutually nested, as in the other embodiments. According to the arrangement of FIG. 15 in which the cover rests on the bottom piece, the free space 208′ formed between the cover and the base has a height greater than that of the spaces 8′ and 108′ above. If a boss is made to raise the cover, this space then has dimensions similar to those of the previous embodiments.

According to an advantageous feature not shown on the figures, which can be combined with any of the embodiments above, the device can comprise sealing means. In particular, a seal of any suitable type, made for example of rubber, can be provided, which is inserted between the walls opposite the sole and the bell. This seal then ensures tightness with respect to the receiving enclosure, which is particularly advantageous in the case of liquids or semi-liquids.

The above description highlights the various advantages of the invention.

First of all, the presence of a receiving enclosure, with two different configurations, guarantees optimal packaging whatever the type of food product. So, in the first configuration, the generally flat surface of the plate allows easy placement of the pizza, or any other similar product. Furthermore, in the second configuration, the hollow shape of the bell ensures convenient reception of any type of non-solid dish. Furthermore, there is no food communication between the receiving enclosure on the one hand and the bottom piece and its cover on the other.

The invention provides a considerable improvement, in economic terms, over the prior art. In substance, the device of the invention consists substantially of four main parts, which can be conveniently built separately. Depending on the final size of the packaging device, it is only necessary to vary the diameter or height of each of its parts. Therefore, the tooling required for this manufacturing is considerably simplified. As an example, it can be considered that the packaging device, in accordance with the invention, is accompanied by a cost equal to only approximately one third of that of a conventional double-walled box. In particular, the invention makes it possible to avoid any overmolding operation, which is particularly expensive.

The invention also relies on a concept whereby the operator assembles the packaging device at the same time as filling the food product to be transported. Therefore, this assembling takes place in hidden time. In other words, the overall duration, for the assembling and filling of the packaging device according to the invention, is barely longer or even similar to the duration necessary only for filling a box according to the prior art. Furthermore, a manufacturer producing a packaging device in accordance with the invention may benefit from two different uses for the same device.

Thanks, in particular to the cooperation of shapes between the bottom pice and the cover, the transport of the food product can be carried out in complete safety. Furthermore, during this transport, this product is kept at an optimal temperature, without significant loss of heat. In this spirit, the device according to the invention has a high thermal insulation capacity. In addition, the presence of the various intercalary spaces creates an air space, contributing to this thermal insulation.

Once the packaging device has arrived at the place of consumption, it is possible to conveniently remove the cover opposite the bottom piece. For this purpose, we will note the possibility of sliding between this cover and this bottom piece, in a vertical direction. Unlike certain prior art boxes which involve an articulation of the cover on the bottom piece, this sliding movement allows a circular shape of the device, which guarantees a saving of material.

It should also be noted that the combination of a plastic material, for example bioplastic, and stainless steel is particularly advantageous.

On the one hand, such a plastic material can easily lend itself to marking operations, allowing the manufacturer′s name to be identified, for example. Furthermore, this material is capable of being manufactured industrially in large series, given its moldable nature. Finally, in the case of a bioplastic material, the latter presents remarkable ecological characteristics.

On the other hand, stainless steel has high thermal insulation properties. In particular, it is likely to induce electromagnetic radiation reflecting heat towards the food product. Furthermore, in the first configuration, the consumer is likely not only to cut the solid product on the stainless steel sole, but also to consume it directly on this sole which then forms a flat plate. Furthermore, in the second configuration, the consumer is likely to taste the non-solid product directly in the bell, which then forms a hollow plate.

The use of these two distinct materials also allows separate treatment between the cover and the bottom piece on the one hand, and the receiving enclosure on the other. Due to its stainless steel construction, this enclosure can be conveniently washed at high temperatures independently of the bottom piece and the cover. On the other hand, the latter, due to their more fragile plastic nature, are subject to less aggressive washing. In particular, in the case of a bioplastic material that cannot withstand a temperature of more than 30° C., the bottom piece and the cover are only subject to aseptic wiping. Finally, the stainless steel parts on the one hand and the plastic parts on the other can be destroyed and recycled separately after prolonged use.

1-22. (canceled)

23. A packaging device for packaging a solid food product type and a non-solid food product type, the packaging device comprising:
a bottom piece;
a cover movable relative to the bottom piece between a closed position to delimit an interior volume and an access position for access to the interior volume; and
a sole and a bell forming, in the interior volume, a substantially closed receiving enclosure operable to receive the solid food product type and the non-solid food product type, the sole and the bell movable between:
a first configuration in which the sole rests on the bottom piece to facilitate receipt of the solid food product type by the receiving enclosure, and
a second configuration in which the bell rests on the bottom piece to facilitate receipt of the non-solid food product type.

24. The packaging device of claim 23, wherein:
the bottom piece and the cover are at least partly formed of a moldable plastic material, and
the sole and the bell are formed of stainless steel.

25. The packaging device of claim 23, wherein in the first configuration:
the bell and the cover mutually delimit a first, upper intermediate space for thermal insulation, and
the sole and the bottom piece mutually delimit a first, lower intermediate space for thermal insulation.

26. The packaging device of claim 25, wherein in the second configuration:
the sole and the cover mutually delimit a second, upper intermediate space for thermal insulation, and
the bell and the bottom piece mutually delimit a second, lower intermediate space for thermal insulation.

27. The packaging device of claim 26, wherein in:
the first configuration the sole and the bell delimit zones of mutual nesting, and
the second configuration the sole and the bell delimit zones of mutual nesting.

28. The packaging device of claim 26, wherein:
only in the second configuration the sole and the bell delimit a mutual nesting zone, and
in the first configuration the sole has a rim projecting opposite the bell.

29. The packaging device of claim 28, wherein in the first configuration the rim rests on the bottom piece to define the first, lower intermediate space.

30. The packaging device of claim 28, wherein in the first configuration, an upper surface of the sole is located at a height substantially equal to that of an upper surface of the bottom piece.

31. The packaging device for packaging of claim 30, wherein:
in the first configuration the bottom piece and the sole mutually delimit a first blocking zone, and
in the second configuration the bottom piece and the bell mutually delimit a second blocking zone.

32. The packaging device of claim 31, wherein:
the bottom piece comprises support means operable to support the sole in the first configuration and the bell in the second configuration, and
the support means comprises a continuous peripheral collar or a plurality of point supports.

33. The packaging device of claim 31, wherein the bottom piece comprises a base extending upwardly by a seat having a planar internal face that defines the first blocking zone with the sole and with the bell.

34. The packaging device of claim 31, wherein the cover is movable relative to the bottom piece, between the closed position and the access position, according to a vertical sliding movement with reference to a device resting on the bottom piece.

35. The packaging device of claim 34, further comprising a locking mechanism defined by at least one pin in a side wall 13 of the bottom piece that cooperates with a notch at the lower end of the cover to facilitate locking between the bottom piece and the cover.

36. The packaging device of claim 35, wherein the cover has an internal diameter that facilitates the which is close to the external diameter of the bottom piece (1), the internal wall of this cover being capable of covering the external wall of this bottom piece.

37. The packaging device of claim 23, wherein the sole includes a plurality of holes allowing evacuation of condensation from the solid food product type, in the first configuration.

38. A method of packaging a solid food product type and a non-solid food product type, the method comprising:
assembling a packaging device by:
providing a bottom piece, a cover movable relative to the bottom piece between a closed position to delimit an interior volume and an access position for access to the interior volume, and a sole and a bell forming, in the interior volume, a substantially closed receiving enclosure operable to receive the solid food product type and the non-solid food product type;
moving the sole and the bell to a first configuration in which the sole rests on the bottom piece to facilitate receipt of the solid food product type by the receiving enclosure; and
moving the sole and the bell to a second configuration in which the bell rests on the bottom piece to facilitate receipt of the non-solid food product type.

39. The method of claim 38, further comprising filling the solid food product type and the non-solid food product type at a same time as assembling the bottom piece, the cover, the sole and the bell.

40. The method of claim 39, further comprising heating, immediately before filling the solid food product type and the non-solid food product type, the sole and the bell to a temperature value approximately a same as a temperature value of the solid food product type and the non-solid food product type.

41. The method of claim 38, further comprising:
placing the sole on the bottom piece;
placing the solid food product type on the sole;
placing the bell on the sole to form the receiving enclosure; and
covering the receiving enclosure with the cover.

42. The method of claim 41, further comprising:
placing the bell on the bottom piece;
pouring the non-solid food product type in the bell;
placing the sole on the bell to form the receiving enclosure; and
covering the receiving enclosure with the cover.
